(19) United States
(12) Patent Application Publication
(10) Pub. No.: US 2013/0253815 A1
(43) Pub. Date: Sep. 26, 2013

(54) SYSTEM OF DETERMINING INFORMATION ABOUT A PATH OR A ROAD VEHICLE

(71) Applicant: INSTITUT FRANCAIS DES SCIENCES ET TECHNOLOGIES DES TRANSPORTS, DE L'AMENAGEMENT, (US)

(72) Inventors: Olivier ORFILA, BUC (FR); Dominique GRUYER, BEYNES (FR); Sebastien GLASER, FONTENAY LE FLEURY (FR)

(73) Assignee: INSTITUT FRANCAIS DES SCIENCES ET TECHNOLOGIES DES TRANSPORTS, DE L'AMENAGEMENT, CHAMPS SUR MARNE (FR)

(21) Appl. No.: 13/848,428

(22) Filed: Mar. 21, 2013

(30) Foreign Application Priority Data
Mar. 23, 2012 (FR) 1252637

(51) Int. Cl. G08G 1/16

(52) U.S. Cl. CPC G08G 1/163
USPC 701/301

(57) ABSTRACT

A method of determining information relating to a path of a road vehicle, the method comprising a step a):
a) determining at least two possible paths for the vehicle, referred to as “reference” paths;
wherein the method further comprises a step e):
e) determining information relating to an intermediate path lying between the reference paths and as a function of the reference paths.

### FIELD OF THE INVENTION

The invention relates firstly to a method of determining information about a path of a road vehicle, which information is likely to be of use in driving the vehicle.

### BACKGROUND OF THE INVENTION

In usual manner, methods of this type are performed by generating a large number of paths envisaged for the vehicle, by comparing the respective advantages and consequences in the event of the vehicle following those paths, and deducing the looked-for information in conclusion. Such a method has the drawback of consuming large amounts of calculation time.

### OBJECT AND SUMMARY OF THE INVENTION

Consequently, a first object of the invention is to provide a method of determining information of the type described above and capable of providing information that is useful for driving the vehicle, and of doing so in very limited calculation time.

This object is achieved by the fact that the method of determining information relating to a path of a road vehicle comprises the following steps a) and e):

a) determining at least two possible paths for the vehicle, referred to as “reference” paths; and

e) determining information relating to an intermediate path lying between the reference paths and as a function of the reference paths.

In particular, the reference paths may be extreme paths that are possible for the vehicle, i.e. the boundary of the set of possible paths. Advantageously, the intermediate path(s) is/are not calculated (or at least do not need to be calculated), thereby having the effect of the method requiring calculation time that is short.

In the above definition and more generally throughout the present document:
the paths of moving bodies and of the vehicle fitted with the present invention are determined in a space that is two-dimensional, or preferably three-dimensional, and that is as representative as possible of the environment of the vehicle. Preferably, the trajectories are defined relative to a terrestrial reference frame (or relative to the ground), rather than relative to the frame of reference specific to the vehicle;
possible paths are paths that the vehicle can follow taking into account on one hand intrinsic features of the vehicle (acceleration limits, turning radius, etc.), and on the other hand driver-related features (maximum acceleration/braking deemed acceptable, etc.).
the term “is suitable for” is synonymous with “includes means for”;
the term “path” (or “track”) designates a curve in space along which the vehicle or the moving body can travel. The path is defined independently of the speed along which it is traveled;
conversely, the dynamic profile is a vector made up of the position, the speed, and the acceleration of the element under consideration, and expressed as a function of time. The dynamic profile thus defines the rate at which the element under consideration travels along the path. In practice, it may be defined by the variations as a function of time of a single “first variable” that may be the position, the speed, or the acceleration of the element under consideration traveling along the path under consideration; the other two variables can then be deduced from the first by differentiating it or by integrating it. The dynamic profile preferably takes account of the six degrees of freedom of the element under consideration. It could equally well take account of only some of those degrees of freedom, in particular two movements in translation in the horizontal plane, together with yaw rate; and
the probability of a dynamic profile is the probability that the vehicle or the moving body will travel along the path to which the dynamic profile corresponds when following the dynamic profile under consideration.

The following various improvements may be applied to the method, singly or in combination:
in step e), the information relating to an intermediate path may be determined as a function of the position of at least one point of the intermediate path relative to the reference paths;
the method may also comprise the following steps b) and c):
   b) determining a reference dynamic profile for the course of each of the reference paths (in particular by minimizing a criterion relating to the speeds and/or accelerations of the vehicle); and
   c) determining a vehicle time slice corresponding to an instant (t0+k Δt) by interpolating points reached at that instant on said reference paths as traveled in accordance with their respective reference dynamic profiles, a vehicle time slice being all of the points that might be reached by the vehicle at an instant (t0+k Δt) under consideration;

and in step e), the information is determined by means of said time slice.

Under such circumstances, the method may include the following step d):

d) determining a probability of the vehicle passing via a point of the vehicle time slice as a function of the position of said point on the vehicle time slice; and
the method may then further comprise the following steps:
   a2) for an body moving relative to the vehicle, determining at least two body reference paths;
   b2) for the course of each of the body reference paths, determining a reference dynamic profile;
   c2) determining an body time slice corresponding to said instant by interpolating points reached at that instant (t0+kΔt) on said body reference paths as traveled in accordance with their respective dynamic profiles; and
   d2) determining a probability for the body passing via a point of the body time slice as a function of the position of said point on the body time slice; and also

in step e), said information is a probability of collision between the vehicle and the body at a point of intersection between the time slices of the vehicle and of the body, if such a point exists; and

said probability of collision is equal to the product of the probabilities for the vehicle and the body to pass at said collision point at said instant.

Advantageously, the method of the invention may be used for evaluating the relative advantages and the possibilities of adopting the various paths (and the associated dynamic profiles).

The method can thus be used for facilitating inserting the vehicle into a stream of traffic, or at least for making it easier for the vehicle driver to decide where to insert into the traffic, or at an intersection, or more generally to follow a given path. (The term “vehicle driver” is used herein broadly to mean a human driver, an automatic vehicle driving system, etc.)

In order to implement the method for this purpose, steps a) to d) and a2) to d2) are performed for a sequence of instants later than the instant under consideration; and the method further comprises the following steps:

f) for a path and a dynamic profile envisaged for the vehicle, or from among all of the collisions envisaged for the vehicle, determining a probable collision point for which the probability of collision is a maximum;

g) determining the so-called “avoidance” path and the associated avoidance dynamic profile, for said mobile body, that enable the moving body to avoid the collision, while reaching a predetermined so-called “pre-accident” limit value (e.g. with the moving body passing or stopping at some minimum distance of the vehicle); and

h) performing a comparison to determine whether the avoidance path and dynamic profile satisfy or not a predetermined acceptability criterion for the moving body.

The invention also provides a computer program including instructions for executing steps of the above-described method when the program is executed by a computer, and a computer-readable recording medium on which there is recorded a computer program including instructions for executing steps of the method described above.

The method also provides an assistance system for a road vehicle. The system comprises an identification and locating device for identifying and locating moving bodies, and suitable for identifying an body that is movable relative to the vehicle and for estimating at least one position thereof relative to the vehicle.

The system also includes a calculation unit suitable for implementing the above-defined method.

Although only one moving body is mentioned, it should naturally be understood that the identification and locating means are suitable for detecting a plurality of moving bodies close to the vehicle and for estimating their positions, and furthermore that the processing performed by the calculation unit is performed for each of those moving bodies.

The calculation unit performing the above-defined method enables the assistance system to provide the vehicle driver with information that is useful for driving the vehicle, without the calculation unit consuming large amounts of calculation power.

A particularly advantageous application of such systems relates to an assistance system for crossing intersections.

Such a system seeks to improve the travel safety of the vehicle by providing information, and where appropriate by triggering alarms or actions, should a risk of collision with a moving body be detected. The moving body may be a pedestrian, a horse and rider, another vehicle, etc.

Such a system is intended for use when the vehicle passes through an intersection, but it may be used under all circumstances.

In a related field, there exist parking assistance systems for providing assistance when parking in reverse. Such systems have sensors suitable for detecting bodies behind the vehicle. On the basis of that information, those systems provide the driver with information to help the driver in particular in leaving a parking place in reverse.

Nevertheless, those systems do not always detect all risks of collision, and they tend to overestimate certain risks of collision. Consequently, those systems can be found to be unusable in terms of systems for providing assistance in passing through intersections.

The invention also includes a system for providing assistance to a road vehicle, the system including an identification and locating device for identifying and locating moving bodies and being suitable for identifying a moving body relative to the vehicle and for estimating at least one position thereof relative to the vehicle, which system is suitable for effectively determining the risks of collision with the identified moving body(s), and also for providing effective assistance in driving, in particular when passing through intersections.

Such an assistance system comprises a device for identifying and locating moving bodies that is suitable for identifying a moving body relative to the vehicle and for estimating at least one position thereof relative to the vehicle, and it also comprises a calculation unit.

For each element among the vehicle and the moving body(s) the calculation unit is suitable for determining:
a bundle of possible paths for the element, that the element might travel along during a future period;
dynamic profiles that are possible for the element as it moves over one or more of the paths of said bundle of paths; and
probabilities for said dynamic profiles.

In addition, on the basis of the bundles of paths and of the dynamic profiles of the moving body and of the vehicle, and also on the basis of the probabilities of said profiles, the calculation unit is suitable for determining a probability of collision between the moving body and the vehicle.

This probability may be quantified in particular in space and in time. The severity of the collision may also be estimated at the same time on the basis of the forecast speeds of the vehicle and of the moving element in question at the time of the envisaged collision, thus making it possible to evaluate directly the risk of collision between the vehicle and the moving body.

In any of the above-defined assistance systems, one or more of the various following improvements may be envisaged.

The probabilities of the paths and/of the dynamic profiles may be a function of at least one predetermined value recorded in a memory of the calculation unit. By way of example, the calculation unit may allocate probabilities to the various dynamic profiles and to the various paths, in particular as a function of the accelerations they involve, by making comparisons with one or more predetermined reference values.

This or these predetermined values may in particular be a value for tangential acceleration, for transverse acceleration, and/or for yaw rate variation, in particular having a value that is representative of the usual or preferable behaviors of the vehicle or of the moving bodies. Tangential acceleration corresponds in particular to the deceleration to which the vehicle is subjected during braking, or indeed on accelerating. Transverse acceleration is acceleration that is substantially horizontal and normal to the direction of the vehicle, and it corresponds to the accelerating that is felt while cornering. It is a function of the speed and of the angular position of the front wheels.

The calculation unit may be suitable for determining reference trajectories for the vehicle and for the body by taking account of a geometrical model of the roadway on which the vehicle is located.

The assistance system of the invention may be installed on board a vehicle. In another embodiment, it may be installed at an intersection in order to improve the safety of the intersection.

For a path under consideration (whether or not it is a reference path), the calculation unit may be suitable for determining a plurality of dynamic profiles corresponding to various criteria. It may thus:
determine a maximum probability profile. The calculation unit then determines a “path and dynamic profile” pair that is not only possible but that also appears to be the most probable, e.g. by assuming minimum accelerations, constant radii of curvature, etc.; and
determine limiting dynamic profiles, respectively “fast” and “slow” limiting profiles, that correspond to speeds for traveling along the path that are respectively as high as possible and as low as possible (possibly going down to stopping). These limit profiles may for example take account of maximum accelerations or decelerations to which the vehicle or the moving body can be subjected, and/or minimum or maximum authorized speeds.

The dynamic profiles that are envisaged may be determined by using minimizing criteria (e.g. minimizing accelerations), and/or criteria merely involving complying with certain thresholds or limits (speed less than 50 kilometers per hour (km/h), transverse acceleration less than XX meters per second squared (m/s²), etc.).

Various provisions may be used for determining the bundles of paths and the dynamic profiles.

In one embodiment, in order to determine the reference paths and/or the reference dynamic profiles, the calculation unit is suitable for taking account of a time-varying tangential and/or angular acceleration of the moving body and/or of the vehicle (during the envisaged future period).

These degrees of freedom make it possible to take account of possible movements of the vehicle and/or of the moving body in realistic manner.

In particular, when an acceleration that varies as a function of time is taken into account, the calculation unit takes account of an acceleration of the vehicle and/of the moving body that is/are different from the values that would apply in the event of the steering wheel position and the speed remaining constant (no actuation of the steering wheel, or of the accelerator, or of the brakes).

Consequently, the calculation unit is suitable for taking account of an acceleration of the vehicle other than the acceleration to which it is subjected on traveling along a circular path at constant speed; and likewise, it is suitable for taking account of an acceleration of the moving body that is not limited to the acceleration to which it is subjected on traveling along a circular path at constant speed, including possibly superposing on the acceleration a deceleration and/or a yaw rate that differs by a predefined fixed value from the yaw rate at the instant under consideration.

Furthermore, the quantity of information produced by the assistance system of the invention increases with the increasing amount of information available to the system for evaluating the risk of collision.

First information that is important for the system is the acceleration to which the moving body(s) is/are subjected. This data may be measured and/or calculated.

In an embodiment, the device for identifying and locating moving bodies is suitable for measuring an acceleration of a moving body, which measured acceleration can be then be used in particular for defining the dynamic profile.

If this information is not measured, the calculation unit may be suitable for calculating it on the basis of position or speed information as delivered by the identification and locating device.

Furthermore, the system preferably includes a device that delivers the speed of the vehicle relative to the ground. The calculation unit and/or the identification and locating device may be suitable for using this information in order to distinguish between information relating to the moving body and information relating to the stationary environment of the vehicle.

Preferably, the calculation unit includes a memory for storing history information relating to the positions, speeds, and/or accelerations of the vehicle and/or of the moving body and relating to past, present, and/or future periods of time, and the calculation unit is suitable for using certain types of history information for determining the bundle of trajectories and/or the dynamic profiles. In practice, and in general, with the exception of data that is too old, all of the information relating to past positions and to previously-estimated future positions is stored and available to the calculation unit.

The calculation unit may preferably have recourse to a geometrical model of the intersection in order to establish the paths and the dynamic profiles. Thus, in an embodiment, the calculation unit is suitable for establishing the geometrical model of the intersection situated on the path of the vehicle. This intersection is the intersection where the vehicle is arriving at the moment when the assistance system is put into operation. Obtaining a geometrical model of the intersection makes it possible to limit the paths that the system takes into account to a single subset of paths that are indeed possible given the road infrastructure.

The geometrical model of the intersection may be obtained in various ways.

In one embodiment, the calculation unit is suitable for establishing the geometrical model of the intersection from at least one path of a vehicle that has already passed through the intersection.

Since the assistance system is above all useful on very busy intersections, the geometrical model of such intersections can very often be reconstructed merely from the paths followed by various vehicles that have passed through the intersection.

In one embodiment, the assistance system includes an environment acquisition device suitable for delivering environmental information relating to the spatial configuration of the environment of the vehicle, and the calculation unit is suitable for using said environment information for establishing the geometrical model of the intersection, and/or for determining said bundle of paths and/or said dynamic profiles.

The acquisition device may in particular be any of three types: firstly, it may be a geographical positioning system of the global positioning system (GPS) type. Under such circumstances, the geometrical model of the intersection, or information about it, is downloaded from the information delivered by the GPS. It may equally well include any type of device for acquiring road signs. Certain road signs indicate the proximity of an intersection and in some circumstances also its configuration; detecting these signs thus makes it possible to build a model of the intersection, possibly an approximate model. The acquisition device may also be a device for acquiring the shape of the environment. Under such circumstances, it may be the same as the device for identifying and locating a moving body.

The calculation unit may also be suitable for establishing a geometrical model of the intersection from a standard intersection model recorded in a memory of the unit.

Once the geometrical model of the intersection has been constructed, the calculation unit is suitable for determining, for each of the elements among the vehicle and the moving body, one or more possible trajectory bundles envisaged for the element by taking account of the geometrical model of the intersection.

It then remains to evaluate from among the various possible paths, which paths will indeed be followed, and at what speed.

In order to evaluate that, in one embodiment, the assistance system further comprises an intention acquisition device suitable for providing intention information selected from among: an angular position (a), a speed of rotation, or an angular acceleration of the steering wheel; or indeed the state of a vehicle direction indicator; and the calculation unit is suitable for using said intention information in order to determine said bundle of trajectories and/or said dynamic profiles. The intention information makes it possible in particular to establish paths and dynamic profiles that are particularly probable, in the light of the attitude of the driver of the vehicle (or of the driver of a vehicle identified among the moving bodies).

In a first embodiment, dynamic profiles and their respective probabilities are established in two stages.

In order to determine said dynamic profiles and their probabilities, the calculation unit is suitable, for each element among the vehicle and the moving body:
for beginning by determining a command enabling the element under consideration to move along a path of the bundle of paths determined for that element, and a probability of such a command; and thereafter
for determining a dynamic profile of the element when the command is applied thereto as it is moving along the path. The probability of a dynamic profile is considered as being equal to the probability of the command envisaged for the element under consideration. The command may be a command to brake before the intersection followed by a command to accelerate on leaving the intersection, associated with a command applied to the steering wheel.

When intention information is available, it is naturally used by the calculation unit, which makes use of this intention information in order to determine the probability of the command being applied to the element under consideration (and/or a probability of said command).

In order to reassure the driver of the vehicle not only that the intersection will be crossed without collision, but also that it will be crossed without disturbing traffic, i.e. without unacceptably hindering other vehicles or moving bodies, the information determination method according to the present invention may further comprise the following steps:

f) for a path and a dynamic profile envisaged for the vehicle, or from among all of the collisions envisaged for the vehicle, determining a probable collision point for which the probability of collision is a maximum;

g) determining the so-called “avoidance” path and the associated avoidance dynamic profile, for said mobile body, that enable the moving body to avoid the collision while reaching a predetermined so-called “pre-accident” limit value; and

h) performing a comparison to determine whether the avoidance path and dynamic profile satisfy or not a predetermined acceptability criterion for the moving body.

The ‘pre-accident’ limit value can for instance be a minimal distance that must be maintained at any time between the vehicle and the other bodies moving around it.

The comparison delivers a value referred to as “hindrance to the moving body” that may be binary or continuous (and/or be multi-components). The hindrance to the moving body may have a value of 0% when the moving body has no need to decelerate specifically because of the presence of the vehicle (it is not hindered by the arrival of the vehicle); it may have a value of 100% when deceleration is required that is not less than the deceleration that corresponds to emergency braking, in order to enable the moving body to avoid collision or rather to limit the severity of collision.

Various parameters may be involved in calculating hindrance to the moving body, and in particular the relative speeds of the vehicles, and also one or more parameters associated with the psychology of the driver, which may for example be involved in the form of a coefficient that is applied to the safety distance, to acceptable deceleration values, etc.

In one embodiment, the calculation unit is suitable for determining the dynamic profiles and/or their probabilities as a function of the hindrance to the moving body. In particular, the higher the hindrance to the moving bodies for a particular “trajectory and dynamic profile” pair under consideration, the lower the probability that is given to that pair.

Finally, in order to improve the service provided by the assistance system, the assistance system may also include means for broadcasting and/or making direct use of the information it produces.

Thus, the system may include means for informing the driver, which means may be visible, in particular involving augmented reality and/or a head-up system, audible, and/or haptic.

Furthermore, the calculation unit may also be suitable for transmitting an action command that is applicable to a driving and/or safety member of the vehicle, e.g. a braking or acceleration command; a position or a movement of the steering wheel; or indeed pretensioning safety belts and/or a front shield, etc. Such an action setpoint is then applied to the members of the vehicle without action or checking on the part of the driver of the vehicle.

Finally, the invention provides a road vehicle including an assistance system as defined above.

The road vehicle may include at least one control member, e.g. a brake or a steering member, and means for actuating the member, and the assistance system is suitable for transmitting an action command as described above directly to the actuation means so as to trigger actuation of the control member without intervention by the driver of the vehicle.

### BRIEF DESCRIPTION OF THE DRAWINGS

The invention can be well understood and its advantages appear better on reading the following detailed description of implementations given as non-limiting examples. The description refers to the accompanying drawings, in which:

FIG. 1 is a diagrammatic view of a road intersection, showing the bundles of paths envisaged for vehicles reaching the intersection;

FIG. 2 is a diagrammatic representation of an assistance system of the invention;

FIG. 3 is a diagrammatic flow chart of information processing steps in the FIG. 2 system;

FIGS. 4a and 4b are curves showing the possible speeds of the vehicle as a function of the path followed and of the control applied to the vehicle as the vehicle passes through the intersection shown by FIGS. 1 and 4;

FIG. 5 is a diagrammatic view of a road intersection showing the path bundles of two vehicles passing through the intersection; and

FIG. 6 is a view presenting a probability curve associated with a time slice appearing in FIG. 6.

### MORE DETAILED DESCRIPTION

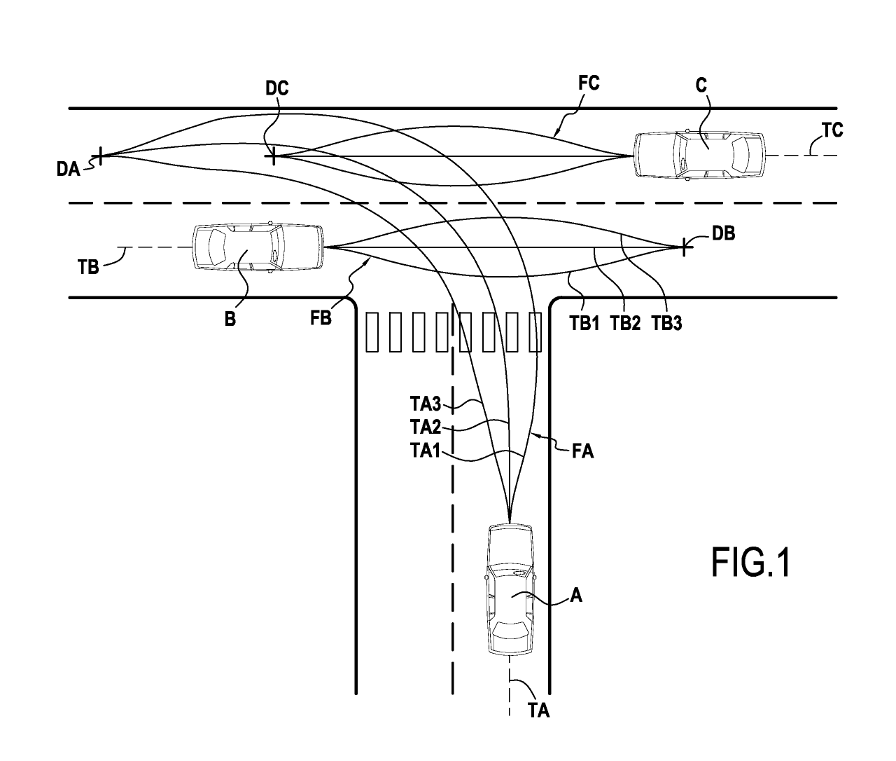

The road intersection or junction shown in FIG. 1 is in the form of an arrival road 10 for a vehicle A and a road 14 perpendicular to the road 10. At the intersection, the vehicle A can thus turn onto the road 14 either to the left or to the right.

By way of example, consideration is given to the vehicle A passing through this intersection at a moment when vehicles B and C are both about to cross the intersection. These vehicles B and C constitute “moving bodies” in the meaning of the invention.

The assistance system of the present invention seeks to help the driver decide whether or not to move onto the road 14 before these vehicles have gone past.

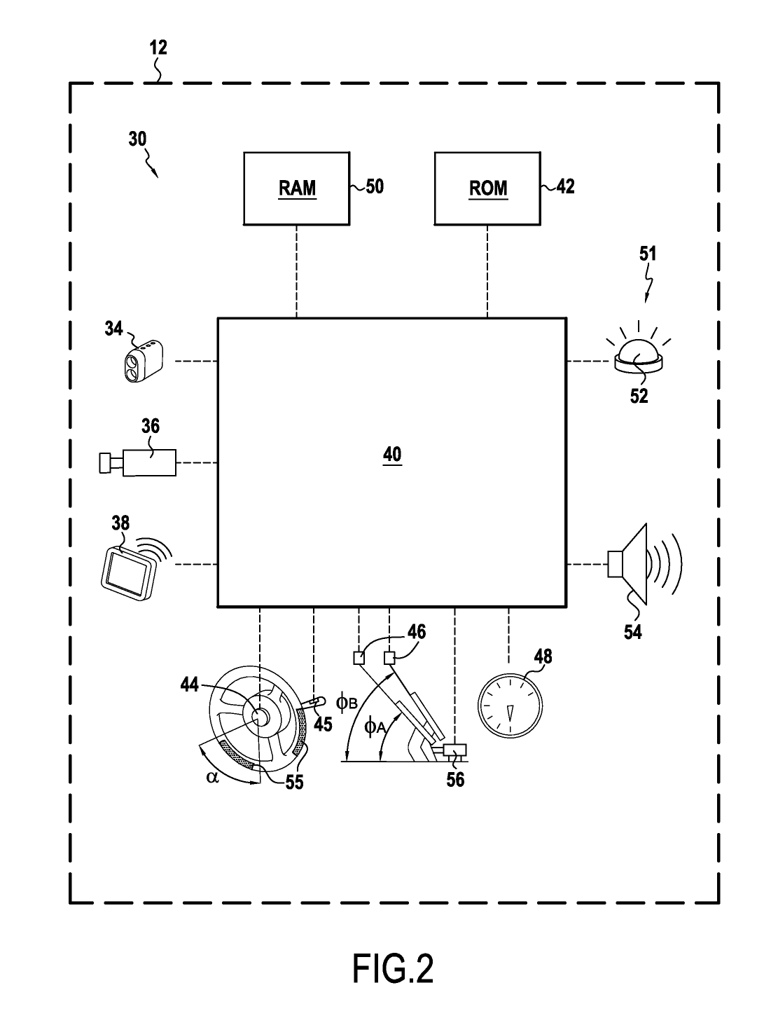

FIG. 2 shows a first embodiment of the present invention, constituted by a driving assistance system 30 installed on board the vehicle A.

The system 30 has a device for identifying and locating moving bodies, the device comprising a telemeter 34 (it may be a telemeter or a 3D scanner) and a camera 36 that are coupled to a calculation unit 40 constituted by one or more computers.

The information delivered by the telemeter 34 and by the camera 36 enables the calculation unit 40 to identify moving bodies present in the vicinity of the vehicle. For each of them, the calculation unit determines position Xi (where i=B for the vehicle B and i=C for the vehicle C) and its speed Vi (i=B,C) relative to the vehicle A.

In particular, on the basis of this information, the calculation unit 40 can reconstruct the paths or tracks of the vehicles B and C as they pass through the intersection. It is thus capable of reconstructing the paths TB and TC of the vehicles B and C.

The system 30 also includes an environment acquisition device comprising a GPS 38 that is also coupled to a calculation unit 40. The environment acquisition device also includes a portion of a read only memory (ROM) 42 of the system 30 having stored therein a geographical map and information describing the three-dimensional configuration of the region in which the vehicle is traveling and including in particular geometrical models of the various intersections in that region.

On the basis of the information delivered by the GPS, the calculation unit 40 extracts from the ROM 42 the three-dimensional model of the intersection at which the vehicle A is arriving.

The assistance system 30 also has angle sensors 44, 46 respectively measuring the angular position α of the vehicle steering wheel, and the angular positions φ_{A}, φ_{B} of the brake and accelerator pedals, and also a sensor for sensing the position of direction indicators 45, and a speed sensor 48.

On the basis of the information from the angle sensor 44 and from the speed sensor 48, the calculation unit 40 is also capable of reconstructing the path TA specific to the vehicle A (FIG. 1).

The system 30 also has a random access memory (RAM) 50. This memory stores all of the information that has been collected or produced by the system 30 up to the instant under consideration, with the exception of time-varying information that is more than 5 seconds old, which information is discarded. In particular, the RAM 50 thus contains in particular path forecasts for the vehicle as made by the calculation unit 40 since activation of the assistance system 30.

Output from the calculation unit 40 is connected to means 51 for providing the driver with information. These means comprise a light-emitting diode (LED) 52 for creating a visible alarm signal, a loudspeaker 54 for creating an audible alarm signal, and vibrating strips 55 on the steering wheel for generating a haptic alarm signal (i.e. a signal that can be felt).

The calculation unit 40 is also connected to an actuator, specifically an actuator 56 arranged to be capable of actuating the brake pedal of the vehicle. Thus, a braking command transmitted by the unit 40 to the actuator 56 causes the brake pedal to be pressed down and the vehicle to be braked by the actuator 56, without intervention by the driver of the vehicle.

The operation of the assistance system 30 is described below with reference to FIGS. 1, 3, 4a and 4b.

The system 30 may operate continuously or it may be activated only on approaching an intersection.

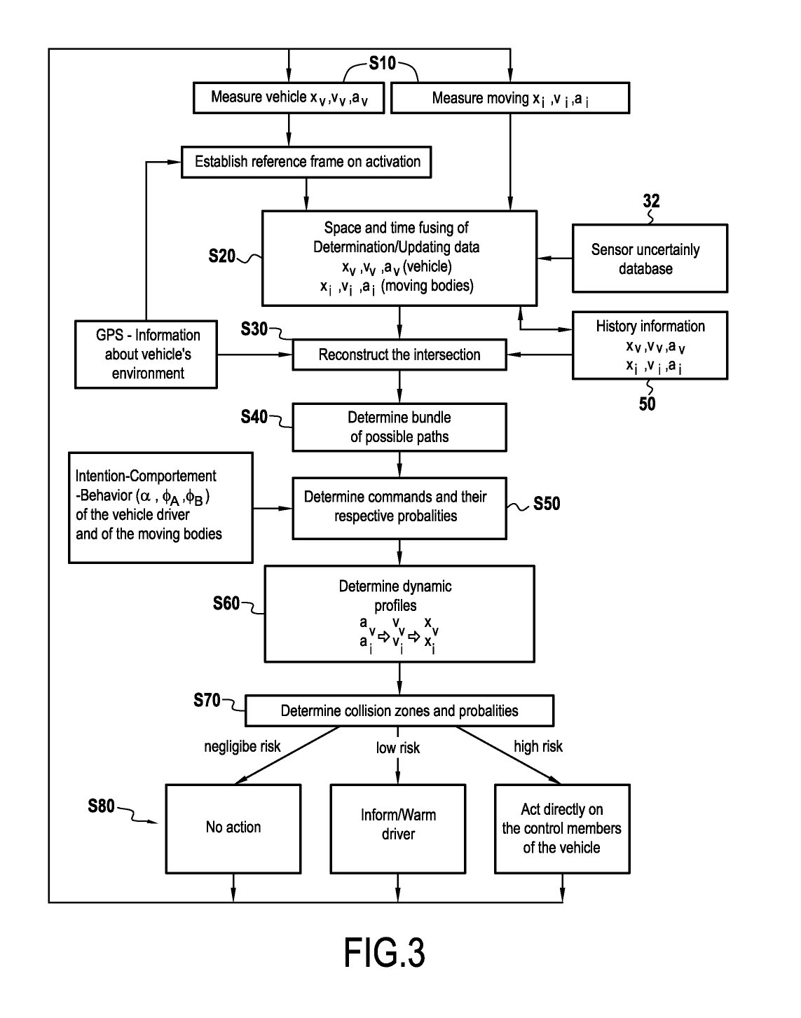

If it is activated only on approaching an intersection, it may be put into operation either manually by the driver, or else automatically by the calculation unit 40 using information from the GPS 38. The calculation unit 40 then executes the algorithm of FIG. 3 in a loop until the vehicle A has left the intersection.

It is assumed that at an instant t0, the vehicle A is arriving at the intersection shown in FIG. 1, that the vehicles B and C will shortly be moving onto the intersection, and that the assistance system is active.

From this instant, the sensors of the system 30 provide the system with the following information needed for its operation (processing step S10): the telemeter 34 and the camera 36 collect information concerning the distance, the position, and the speed of each identified moving body, together with images thereof.

This information is initially delivered in the frame of reference of the vehicle.

The speed of the vehicle relative to the ground is then used by the calculation unit 40 in order to extract from the information delivered by the telemeter 34 and the camera 36 information about the moving bodies and in order to distinguish that information from information relating to the stationary environment of the vehicle, i.e. the road infrastructure.

In association with the ROM 42, the GPS 38 delivers the position of the vehicle, and the three-dimensional configuration of the intersection.

Finally, the RAM of the calculation unit 40 delivers information about the positions, speeds, and accelerations of the vehicle and of the identified moving bodies, as measured or estimated at earlier instants and at the present instant.

A stationary frame of reference (tied to the ground) is defined when the assistance system 30 is activated. During this activation, the calculation unit 40 defines a stationary frame of reference tied to the ground that is used throughout the passage through the intersection (a step of establishing a reference frame).

In a second processing step S20, the calculation unit 40 fuses in time and in space the various items of information relating to the positions, speeds, and accelerations of the various moving bodies (specifically the vehicle and the other identified moving bodies). It thus determines the position Xv, the speed Vv, and the acceleration Av of the vehicle in the frame of reference relative to the ground, and also the position Xi, the speed Vi, and the acceleration Ai of each of the identified moving bodies. For example, starting from the instant shown in FIG. 1, the two vehicles B and C are identified; their positions, speeds, and accelerations are then determined (or updated during successive loops of the algorithm performed by the calculation unit 40).

In this operation, measurement uncertainties of the various sensors, as recorded in a database 32, are taken into account.

In a third processing step S30, the calculation unit 40 reconstructs the geometrical model of the intersection, and then in subsequent loops updates it. For this purpose, the calculation unit 40 uses GPS data to download a three-dimensional model of the intersection on the basis of information delivered by the GPS 38. The calculation unit resets the theoretical model in the frame of reference based on the paths TA, TB, and TC of the vehicles A, B, C that are about to cross the intersection. By combining all this information it updates the geometrical model of the intersection, should that be necessary. In the absence of information, in particular of information delivered by the GPS, the geometrical model may be reconstructed solely on the basis of the paths TA, TB, and TC of the vehicles that are in the process of crossing the intersection (and/or of other vehicles that are in the process of crossing or have already crossed the intersection, and are tracked by system 30).

In a fourth processing step S40, the calculation unit 40 acts for each moving body (the vehicle A and the identified vehicles B and C) to determine the bundle of paths possible for the moving body, while taking account of the geometrical model of the intersection as determined in step S30. This operation is performed for the vehicle A as well as for the vehicles B and C. As soon as new vehicles arriving at the intersection are identified by the telemeter 34 or the camera 36, these vehicles are identified and then tracked in three dimensions as a function of time.

By way of example, when the vehicle A is in the position shown in FIG. 1, during the step S40, the calculation unit 40 determines the bundles FA, FB, and FC of paths that are possible for the various vehicles A, B, and C that are shown.

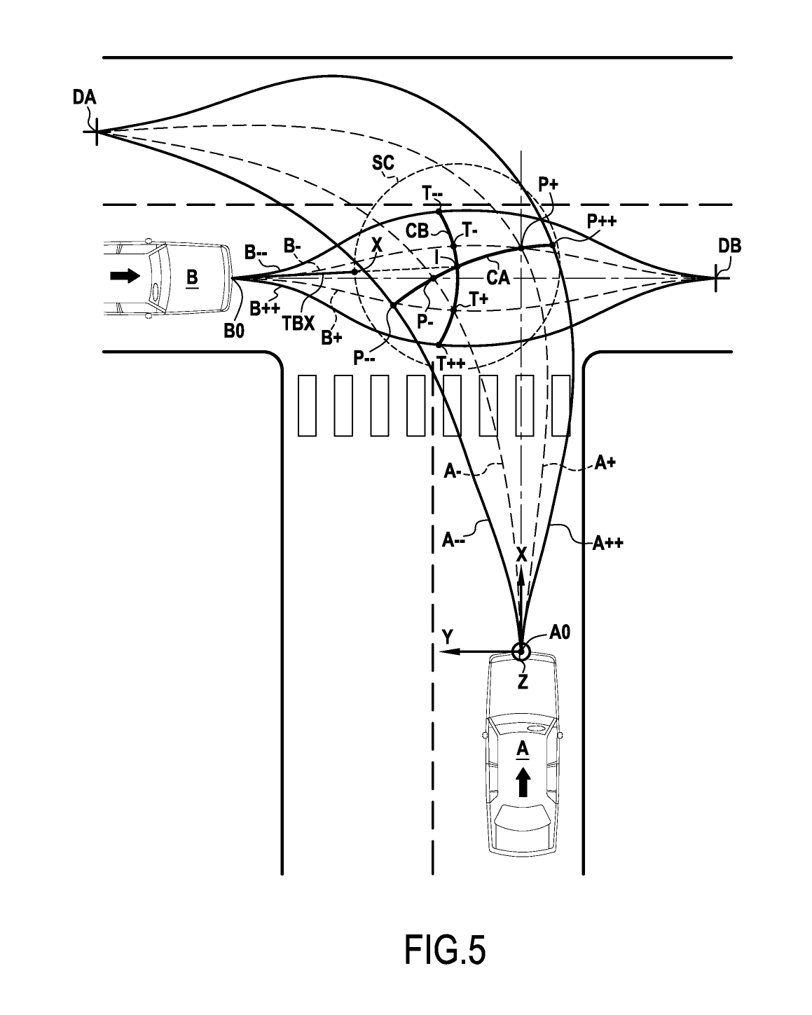

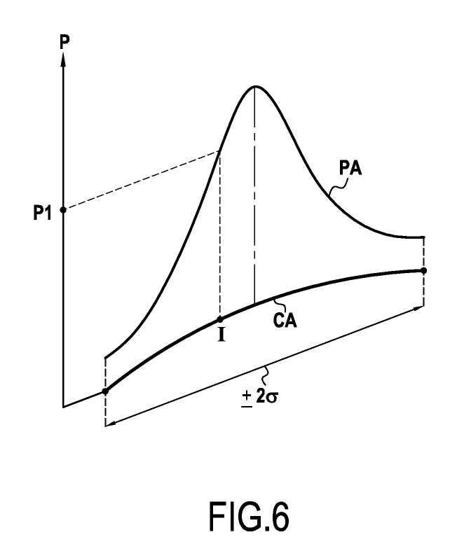

In an implementation of the invention, the bundle may be discrete and comprise only a few envisaged paths (for instance paths TA1,TA2, TA3 and TB1, TB2, TB3 (FIG. 1)). It may equally well comprise an infinity of paths, as it will be described later in relation with FIGS. 5 and 6.

While determining the bundles, the calculation unit 40 limits the number and/or the position and/or the shape of paths it envisages by taking account of various kinds of additional information and applying one or more selection criteria.

In particular, the unit 40 takes account of the geometry of the intersection, of the road surface. To facilitate determination of the bundles of paths (FA, FB, FC), it is supposed that each of these bundles converges on an assumed destination point for the vehicle under consideration. The different destination points are situated on the roads leaving the intersection (destination points DA, DB and DC) towards which it is assumed that the vehicle will go. The calculation unit may possibly take into account multiple destination points, for one bundle of paths, in particular destination points spread on a line segment.

In addition, the bundles of paths are determined based on assumptions about possible behavior of the vehicle (in particular: maximum acceptable tangential, transverse or rotational accelerations and/or decelerations, vehicle turning radius, . . . ). In function of these assumptions, it is possible to take into account greater or smaller bundles of possible paths.

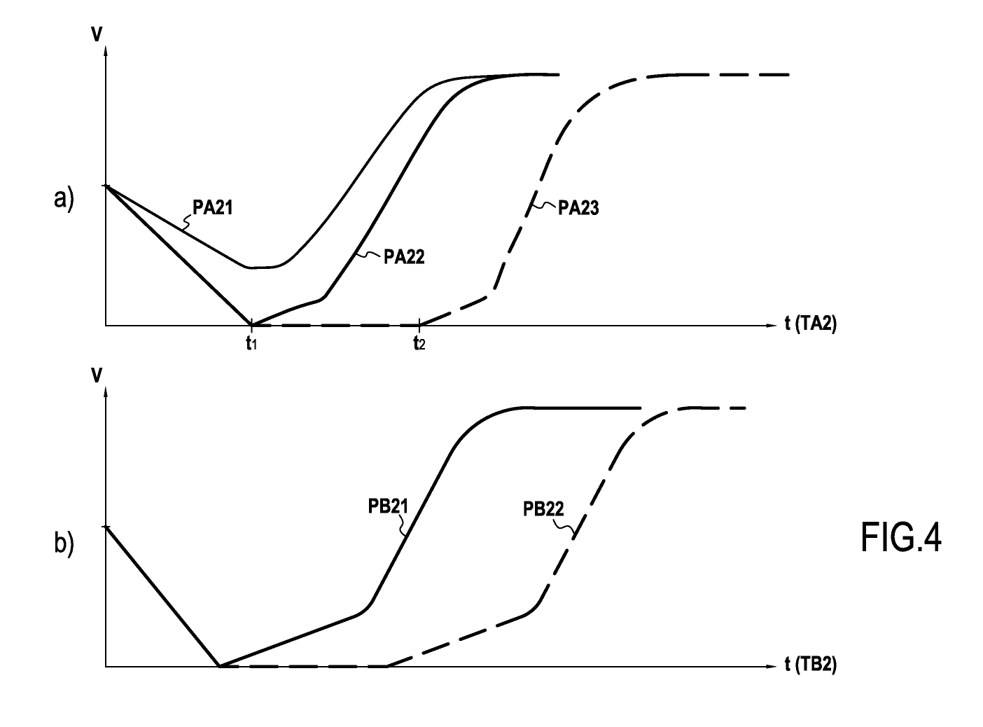

The term “possible path” is used to designate a path that one of the vehicles could follow in order to head to one of the roads leaving the intersection. In the example of FIG. 4, the possible paths for the vehicle A all predict a turn to the left; the possible paths predicted for the vehicles B and C are all straight ahead.

Thereafter, during a fifth processing step S50, the calculation unit 40 acts for each of the moving bodies to determine one or more possible commands for following the paths envisaged in step S40. It also allocates respective probabilities to those various commands.

The commands are determined by taking account of predetermined references concerning the accelerations to which the vehicle in question and the identified vehicles are to be subjected. Various scenarios may be envisaged (slow, fast, etc. as mentioned above), which leads to different applicable commands being defined.

Thereafter, in order to determine the respective probabilities of those various commands, the calculation unit 40 then makes use of intention information available to it. This information relates essentially to the vehicle A rather to the other moving bodies. This information may in particular be the tangential acceleration profile (braking/acceleration) of one of the vehicles; and for the vehicle A itself, the use of a direction indicator showing that the driver intends to turn as determined by the sensor 45; the brake or accelerator pedals being pressed or released, as indicated by the sensors 46; a change in the position of the steering wheel, as indicated by the steering wheel position sensor 44.

Information about the acceptable speeds and accelerations for the vehicles, and about the positions and speeds of the vehicles relative to the intersection, may also be taken into account in order to evaluate the destinations to which each of the vehicles might be heading.

On the basis of all this information, the calculation unit evaluates the probable destinations for the various vehicles. For each command envisaged for a vehicle, it allocates a probability of that command being performed, and thus to the corresponding path (by summing the respective probabilities of the various dynamic profiles calculated for the path). The calculation is performed by a technique of propagating standard errors as a function of time.

The probability is then recalculated or adjusted by taking account of the hindrance to the moving bodies that is associated with a particular “path and dynamic profile” pair. This hindrance varies from 0% when the vehicle under consideration has no need to slow down when the vehicle A crosses the intersection (given the applicable safety distance), to 100% when the vehicle needs to perform deceleration harder than emergency braking.

For this purpose, and for a given “path and dynamic profile” pair, an evaluation is made of the hindrance that results for the other moving bodies because of the moving body under consideration following the path under consideration with the dynamic profile under consideration. The probability of the dynamic profile (associated with the path under consideration) is then adjusted as a function of the result obtained: this probability is reduced to a greater extent when the hindrance induced for the other moving bodies is large.

Naturally, since the data processing performed by the control unit 40 is iterative, the evaluation of the hindrance to the moving body becomes refined progressively as the paths envisaged for the various vehicles are themselves refined. As a vehicle approaches the intersection, the data processing algorithm of the calculation unit 40 puts certain paths further and further aside from the calculation by giving probabilities that are low and then zero to the commands and to the dynamic profiles that are associated with those paths.

Thereafter, during a sixth processing step S60, the calculation unit 40 determines (or updates) the dynamic profiles associated with the various commands calculated during step S50.

By way of example, the dynamic profiles envisaged for the vehicle A when it is in the situation shown in FIG. 1 are shown in FIGS. 4a and 4b. Similar profiles (not shown) are calculated simultaneously for the vehicles B and C.

For each of the paths, one or more commands have previously been identified in step S50. For the path TA2, which consists in the vehicle A turning right (FIGS. 1 and 4a), three different commands are envisaged by the calculation unit 40.

For the first command, the vehicle A decelerates to an instant t1, and then it re-accelerates until it reaches a new cruising speed. These accelerations define a speed profile PA21 which defines the dynamic profile of the vehicle A on the path TA2. For the second and third envisaged commands, the vehicle brakes and stops at the intersection. Thereafter, either it moves on again immediately (speed curve PA22), and accelerates up to cruising speed, or else it waits until an instant t2 before starting again (speed curve PA23).

For the path TB2, which is one of the paths envisaged for the vehicle B (FIGS. 1 and 4b), two different commands are envisaged and they lead to dynamic profiles PB21 and PB22 that are comparable to the profiles PA22 and PA23, with it not being envisaged that the intersection can be crossed without stopping when following the path TB2. Probabilities are calculated by calculation unit 40 for each of the envisaged dynamic profiles.

On this basis, probabilities are given to the various envisaged paths in association with the various dynamic profiles.

Optionally, in addition to the paths explicitely envisaged and defined for the vehicle or a mobile body, called reference paths, intermediate paths also can be taken into account. Such intermediate paths are paths comprising at least one portion located between two reference paths.

In this case, for some intermediate paths, unit 40 sets to the intermediate path and to the associated dynamic profile a probability as a function of the reference paths between which the intermediate path (or a portion thereof) is located. For instance, the probability set to path TB2 and to the associated dynamic profile can be calculated in function of the probability of paths TB1 and TB3, and of the dynamic profiles associated therewith.

Thereafter, during a seventh processing step S70, the calculation unit 40 determines the collision zones and probabilities as a function of the paths and as a function of the dynamic profiles and their respective probabilities, for the various moving bodies.

If a risk of collision is detected, the unit 40 determines the possible collision zones and the envisaged collision probabilities in order to define the level and the type of signal to be transmitted (step S80). Depending on the risks that are identified (where risk depends on the seriousness of the envisaged collision and on its probability), the unit 40 transmits corresponding alarm signals to the driver via the elements 52, 54, and 55.

If the identified solution necessarily requires deceleration (or some other action on a control member of the vehicle) that is greater than a predetermined threshold, then a corresponding command is transmitted to the vehicle. In particular, a braking command may be transmitted to the actuator 56 in order to force the vehicle to brake. Simultaneously, the system 30 also commands forced declutching of the engine.

FIGS. 6 and 7 show with more details how the method pursuant to the invention is implemented and more precisely, how the probability for the vehicle to pass at a given point of an intermediate path can be calculated based on reference paths.

The control unit executes a program that enables the following operations to be performed:

### a) Determining Reference Paths for the Vehicle

For each vehicle at least the following is known:
the origins of the possible bundle of paths for the vehicle (points A0, B0) located at the fronts of the vehicles A and B; and
the destination points of the bundle of possible paths for the vehicle (points DA, DB) on leaving the intersection. A destination point may possibly be replaced by a destination zone, in particular a zone in the form of a segment.

The unit 40 begins by calculating the boundary M of the dynamic profiles. This boundary is an (n,p+1) matrix where n is the number of parameters taken into account, 3 in the present example since the unit 40 takes account of the parameters Vx, Vy (speeds along X and Y, where the axis X is the longitudinal axis of the vehicle A), and Rz which is the yaw rate about the axis Z.

The boundary of the dynamic profiles is calculated by using a Kalman filter in order to predict how the maximum speeds (Vx, Vy, Rz) will vary, given knowledge of the starting state (Vx0, Vy0, Rz0) and of the assumed ending state (Vxf, Vvf, Rzf). The matrix M is:

$$\begin{matrix}( Vx 0 & Vx 0 & Vy 0 & Vy 0 & Rz 0 & Rz 0 ) & 0 \\ ( … & ⋯ & … & … & … & … ) & 1 \\ ( … & … & … & … & … & … ) & . \\ ( … & … & … & … & … & … ) & . \\ ( Vxmin ( k ) & Vxmax ( k ) & Vymin ( k ) & Vymax ( k ) & Rzmin ( k ) & Rzmax ( k ) ) & k \\ ( … & … & … & … & … & … ) & . \\ ( … & … & … & … & … & … ) & . \\ ( … & … & … & … & … & … ) & . \\ ( Vxf & Vxf & Vyf & Vyf & Rzf & Rzf ) & p\end{matrix}$$

wherein: the matrix M comprises p lines corresponding to the p time steps Δt taken into account from starting time t0 to a final time tp.
On a line corresponding to an instant T(k)=t0+kΔt, the matrix M comprises six numbers: Vxmin(k) and Vxmax(k), and Vymin(k) and Vymax(k), which are the minimum and maximum speeds that the vehicle can reach at instant T(k) while moving on one of the envisaged paths, respectively along the X axis (axis of the vehicle at instant t0) and along the Y axis; Rzmin(k) et Rzmax(k) are the minimal and maximal yaw rates which the vehicle can reach at instant T(k) while moving on one of the envisaged paths.

### b) Determining a Reference Dynamic Profile for the Course of Each of the Reference Paths

Operations a) and b) are performed simultaneously using a path-seeking algorithm. It is specified to the calculation unit 40 that the algorithm must minimize one or more predetermined criteria relating to the speeds and/or accelerations of the vehicle. Thereafter, the path-seeking algorithm firstly outputs the extreme paths, i.e. the boundary (in the topological sense) of the bundle of paths, and secondly the dynamic profiles associated with these extreme paths.

These extreme paths (these paths are called extreme since they are the paths for which certain criteria are minimized/maximized, for some predetermined parameter values) are used as reference paths and correspond respectively to the curves A−−, A−, A+, A++ and B−−, B−, B+, B++ on FIG. 5.

The predetermined criterion is normally specified in such a manner that the dynamic profile that is found is a preferred profile for the driver of the vehicle (minimum accelerations, preferred travel speeds).

In practice, the unit 40 takes account of four possible criteria in the implementation described.

The average lateral (or transverse) acceleration usually considered acceptable by the occupants of a vehicle is written Acc. In addition, the unit 40 records the accelerations to which the vehicle A is subjected; the unit 40 thus keeps up to date another value, namely the standard deviation of the lateral accelerations of the vehicle A when the driver controls himself this vehicle, that is, when the unit 40 controls neither the position of the steering wheel, nor the acceleration or braking of the vehicle.

For the mobile bodies other than the vehicle A, a fixed standard deviation σ0 is used.

For each of the vehicles A and B, the unit 40 calculates four reference paths corresponding respectively to the extreme possible paths for lateral accelerations: Acc±σ, Acc±2σ (corresponding to curves A−−, A−, A+, and A++; B−−, B−, B+, and B++).

Simultaneously, the unit 40 determines the dynamic profile associated with each of these paths.

### c) Determining Time Slices

The unit 40 then determines successive time slices for each of the vehicles (or moving bodies) at different time steps Δt taken into consideration between an initial instant t0 and a final instant tp. (The calculation is limited to a time or distance horizon, which can lead to the value of the last step tp being limited).

For each instant t0+k Δt, the unit 40 calculates the position of the four points for each of the vehicles A and B that are situated on the reference paths and at which the corresponding vehicle will be located if it follows the reference dynamic profile.

In FIG. 6, the calculation is shown for an instant t+k Δt.

The unit 40 thus determines points P−−, P−, P+, and P++ for the curves A−−, A−, A+, and A++; and points T−−, T−, T+, and T++ for the curves B−−, B−, B+, and B++.

The unit 40 creates curves CA and CB by interpolation respectively between the points P−−, P−, P+, and P++, and between the points T−−, T−, T+, and T++. The curves CA and CB constitute respective time slices for the vehicle A and for the vehicle B at the instant t0+k·t under consideration.

d) Determining the Probabilities of the Vehicles a and B Passing Via the various points of the time slice

For each time step, the unit 40 then determines the parameters of two Gaussian probability functions PA and PB, the average of which being centered respectively on the curves CA and CB. The functions PA and PB are determined in such a manner that the ±2σ intervals on the Gaussian curves PA and PB correspond to the widths of the curves CA and CB, i.e. respectively from A++ to A−−, and from B++ to B−− (see FIG. 7), with this being because the curves CA and CB themselves are the ±2σ limit curves for the behavior of the driver (or respectively for vehicles in general): the probability curves (PA, PB) are preferably defined by taking account of the probabilities of the underlying reference curves (CA, CB).

By way of example, the curve CA and the corresponding Gaussian probability PA are shown approximately in FIG. 7.

The probabilities PA and PB are considered as representing the probabilities of the vehicles A and B passing via the points under consideration of their respective time slices.

### e) Determining the Probabilities of Collision Between the Vehicles A and B

This calculation is performed for all of the time steps between t0 and tp.

For each time step, the unit 40 determines whether the curves CA and CB have a non-empty intersection. If so, the point of intersection I is a potential collision point; the probability P of a collision occurring at this point is considered as being equal to the product P1·P2, where P1 and P2 are the respective probability values on the curves PA and PB for the point I.

### f) Determining the Probable Point of Collision

Among all of the collision points identified in this way, the unit 40 then determines the point for which the probability of collision P is the greatest.

### g) Determining the Avoidance Path

The unit 40 then determines the so-called “avoidance” path and the associated “avoidance” dynamic profile. This path and dynamic profile are the path and the profile that make it possible firstly for the moving body (the vehicle B) to avoid the collision, and secondly to do so by passing or stopping at a minimum distance (e.g. predetermined as 2 meters) between the vehicles A and B. They therefore correspond to the “path and dynamic profile” pair that requires the minimum avoidance effort on the part of the vehicle B.

This search for the avoidance “path and dynamic profile” pair may possibly be restricted in order to shorten calculation time to a rectilinear path going from the initial position of the vehicle B at instant t0 to the point I, or it may be restricted to a trajectory that is determined by interpolation from the reference trajectories and that take the vehicle B from its initial position to the point I. Either way, this simplifying assumption serves to limit the calculation to calculating the dynamic profile, in particular to calculating braking.

In the present case, unit 40 determines a simplified avoidance path, which is simply the straight line segment TBX joining point A0 to the envisaged most probable collision point I. The associated dynamic profile is then calculated. This profile is the profile which leads the vehicle to stop at a point X located on line TBX at a distance D (radius of the safety circle SC) of point I. The unit 40 then determines the maximum deceleration to which vehicle B is submitted on path TBX according to this dynamic profile. This deceleration is calculated as the smallest deceleration which allows that vehicle B stop at point X.

h) Comparison with a Predetermined Acceptability Criterion

After the avoidance “path (TBX) and dynamic profile” pair has been determined, the unit 40 verifies whether this pair satisfies a predetermined acceptability criterion for the vehicle B.

Unit 40 verifies that the dynamic profile during the avoidance maneuver does not subject the vehicle B to deceleration that is greater than a maximum deceleration normally considered as being accessible by the occupants of such a vehicle.

The acceptability criterion may include one or more of the following criteria: a maximum acceleration and/or deceleration value; a zone on the road where the body cannot be found (off the road) or would rather not be found (too close to the edge of the road surface, or merely shifted away from a path that is considered as being preferred or natural); a predetermined minimum distance to be allowed between the vehicle and the moving body.

What is claimed is:

1. A method of determining information relating to a path of a road vehicle (A), the method comprising the following steps a) et e):
a) determining at least two possible paths for the vehicle, referred to as “reference” paths; and
e) determining information relating to an intermediate path lying between the reference paths and as a function of the reference paths.

2. A method according to claim 1, wherein, in step e), said information is determined as a function of the position of at least one point of the intermediate path relative to the reference paths.

3. A method according to claim 1, further comprising the steps b) and c) of:
b) determining a reference dynamic profile for the course of each of the reference paths; and
c) determining a vehicle time slice (CA) corresponding to an instant (t0+k Δt) by interpolating points reached at that instant on said reference paths as traveled in accordance with their respective reference dynamic profiles, a vehicle time slice being all of the points that might be reached by the vehicle at an instant (t0+k Δt) under consideration;
and in step e), said information is determined by means of said time slice.

4. A method according to claim 3, further comprising a step d):
d) determining a probability of the vehicle passing via a point of the vehicle time slice as a function of the position of said point on the vehicle time slice.

5. A method according to claim 4, further comprising the following steps:
a2) for an body moving relative to the vehicle, determining at least two body reference paths;
b2) for the course of each of the object reference paths, determining a reference dynamic profile;
c2) determining an body time slice corresponding to said instant (t0+k Δt) by interpolating points reached at that instant on said body reference paths as traveled in accordance with their respective dynamic profiles; and
d2) determining a probability for the body passing via a point of the body time slice as a function of the position of said point on the body time slice; and also
in step e), said information is a probability of collision between the vehicle and the body at a point of intersection between the time slices of the vehicle and of the body, if such a point exists; and
said probability of collision is equal to the product of the probabilities for the vehicle and for the object to pass at said collision point at said instant.

6. A method according to claim 5, wherein steps a) to d) and a2) to d2) are performed for a sequence of instants later than the instant under consideration, the method further comprising the following steps:
f) for a path and a dynamic profile envisaged for the vehicle, or from among all of the collisions envisaged for the vehicle, determining a probable collision point for which the probability of collision is a maximum;
g) determining the so-called “avoidance” path and the associated avoidance dynamic profile, for said mobile body, that enable the moving body to avoid the collision while reaching a predetermined so-called “pre-accident” limit value; and
h) performing a comparison to determine whether the avoidance path and dynamic profile satisfy or not a predetermined acceptability criterion for the moving body.

7. A computer program including instructions for executing steps of the method according to claim 1 when said program is executed by a computer.

8. A computer readable recording medium having recorded thereon a computer program including instructions for executing steps of the method according to claim 1.

9. An assistance system for a road vehicle, the system comprising:
a device for identifying and locating moving bodies and suitable for identifying an body moving relative to the vehicle and for estimating at least one position thereof relative to the vehicle,
wherein the system further comprises a calculation unit suitable for implementing the method according to claim 1.

10. An assistance system according to claim 9, wherein, in order to determine the reference paths and/or the reference dynamic profiles, the calculation unit is suitable for taking account of a time-varying tangential and/or angular acceleration of the moving body and/or of the vehicle.

11. An assistance system according to claim 9, wherein the calculation unit is suitable for determining reference trajectories for the vehicle and for the body by taking account of a geometrical model of the roadway on which the vehicle is located.

12. An assistance system according to claim 11, wherein the calculation unit is suitable for establishing the geometrical model of the intersection from at least one path of a vehicle that has already passed through said intersection.

13. An assistance system according to claim 11, wherein the calculation unit is suitable for establishing a geometrical model of the intersection from a standard intersection model recorded in a memory of the unit.

14. An assistance system according to claim 9, wherein the probabilities of the reference paths and/or of the reference dynamic profiles are a function of at least one predetermined value stored in a memory of the calculation unit, and said recorded value is a tangential and/or transverse acceleration value, and/or a value of yaw rate variation, in particular a value representative of usual or preferable behaviors of the vehicle or of moving bodies.

15. A road vehicle including an assistance system according to claim 9.
